(19) United States
(12) Patent Application Publication
(10) Pub. No.: US 2010/0319020 A1
(43) Pub. Date: Dec. 16, 2010

(54) SYSTEMS AND METHODS FOR ADVERTISING TRAFFIC CONTROL AND BILLING

(75) Inventors: Henry C. Yuen, Pasadena, CA (US); Thomas E. Ward, III, Weston, MA (US); Douglas B. Macrae, Weston, MA (US)

Correspondence Address: ROPES & GRAY LLP, PATENT DOCKETING 39/361, 1211 AVENUE OF THE AMERICAS, NEW YORK, NY, 10036-8704, US

(73) Assignee: GEMSTAR DEVELOPMENT CORPORATION, Pasadena, CA (US)

(21) Appl. No.: 12/817,864

(22) Filed: Jun. 17, 2010

Related U.S. Application Data
(63) Continuation of application No. 12/728,959, filed on Mar. 22, 2010.
Application No. 12/728,959 is a continuation of application No. 09/444,170, filed on Nov. 18, 1999, now abandoned.
(60) Provisional application No. 60/108,960, filed on Nov. 18, 1998.

(51) Int. Cl. H04N 7/025; H04N 5/445

(52) U.S. Cl. 725/32; 725/42

(57) ABSTRACT

In one embodiment, the present invention is a computer system for managing advertisements for use in an interactive electronic television program guide (EPG) comprising: a memory storing information regarding advertisements to be displayed on the EPG including one or more of the group of: times of day of ad display, duration of ad displays, location of ad displays, days of week of ad displays, television programs broadcast at or about the time of ad display; rotation rate for ads, number of ads being rotated with the ad, memory required for storage of ad at EPG location, payment rates for ads. The invention determines the distribution of advertisements based on the information stored in the memory and distributes advertisements to the EPG based on the determined distribution.

### CROSS-REFERENCE TO RELATED APPLICATIONS

This application is a continuation of U.S. patent application Ser. No. 12/728,959, filed Mar. 22, 2010, which is a continuation of U.S. patent application Ser. No. 09/444,170, filed Nov. 18, 1999, which claims priority of U.S. Application No. 60/108,960 filed Nov. 18, 1998, the disclosures of which are incorporated fully herein.

### BACKGROUND OF THE INVENTION

Providers of Electronic Program Guide's (“EPG”), such as Gemstar Development Corporation, also provide opportunities for advertisers to reach television viewers through the EPG. While the viewers use the EPG to make program selections and to perform other EPG functions, the EPG will display advertisements. Advertisements to be displayed on a viewer's EPG will be comprised of, among other things, advertising text, graphic objects, and other advertising elements, often referred to in the Advertising Industry as “Ad Creatives.” Ad Creatives can be created and displayed by the host EPG display system in various locations on the EPG. At any one time when the viewer displays the EPG, multiple Ad Creatives may be simultaneously displayed on the EPG display on the viewer's television monitor, or other display device.

International Application No. PCT/US95/11173 (International Publication No. WO 96/07270), the disclosure of which is incorporated by reference herein for all purposes, illustrates an EPG that provides viewer-to-EPG interaction and provides Picture-In-Guide (“PIG”) display of the television program simultaneous with the display of the EPG.

U.S. application Ser. No. 09/120,488, the disclosure of which is incorporated by reference herein for all purposes, illustrates further improvements to an EPG.

### SUMMARY OF THE INVENTION

In one embodiment, the present invention is a computer system for managing advertisements for use in an interactive electronic television program guide (EPG) comprising: means for storing information regarding advertisements to be displayed on the EPG including one or more of the group of: times of day of ad display, duration of ad displays, location of ad displays, days of week of ad displays, television programs broadcast at or about the time of ad display; rotation rate for ads, number of ads being rotated with the ad, memory required for storage of ad at the EPG location, payment rates for ads; means for calculating the distribution of advertisements based on the information stored in said means for storing; and means for distributing advertisements to the EPG based on the output of the means for calculation.

### BRIEF DESCRIPTION OF THE INVENTION

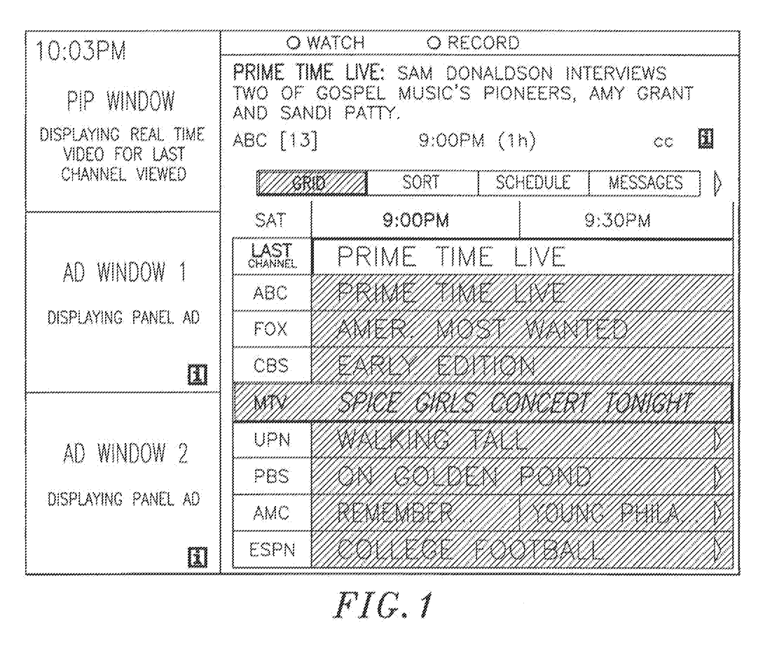

FIG. 1 shows the screen of an Interactive Electronic Program Guide;

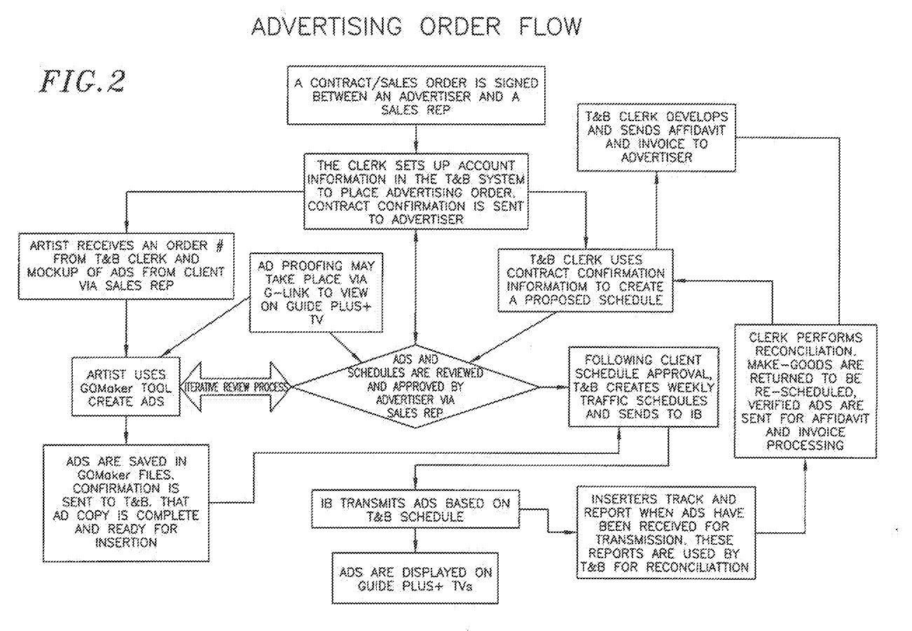

FIG. 2 is a flow chart of a method according to an embodiment of the invention;

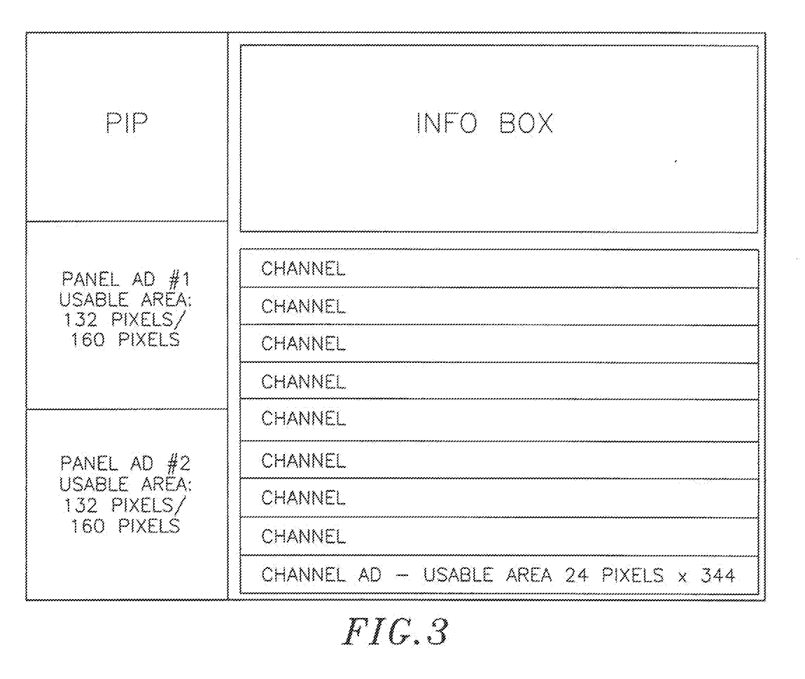

FIG. 3 shows sample Ad types, according to an embodiment of the invention;

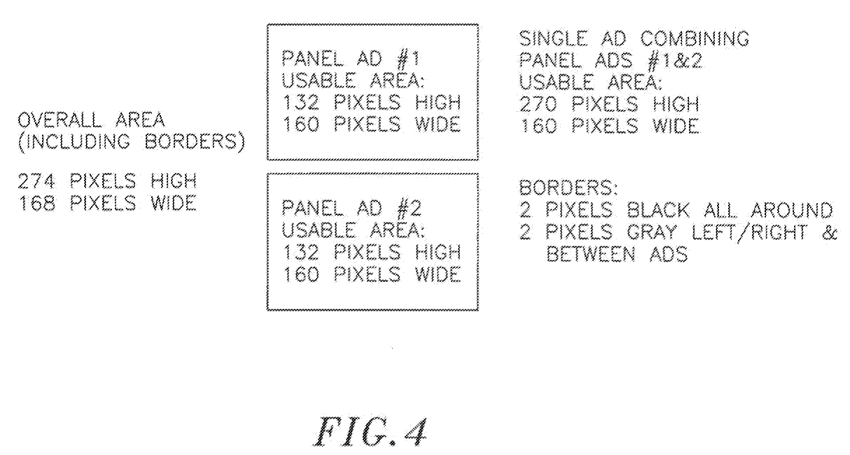

FIG. 4 shows exemplary Ad dimensions, according to an embodiment of the invention;

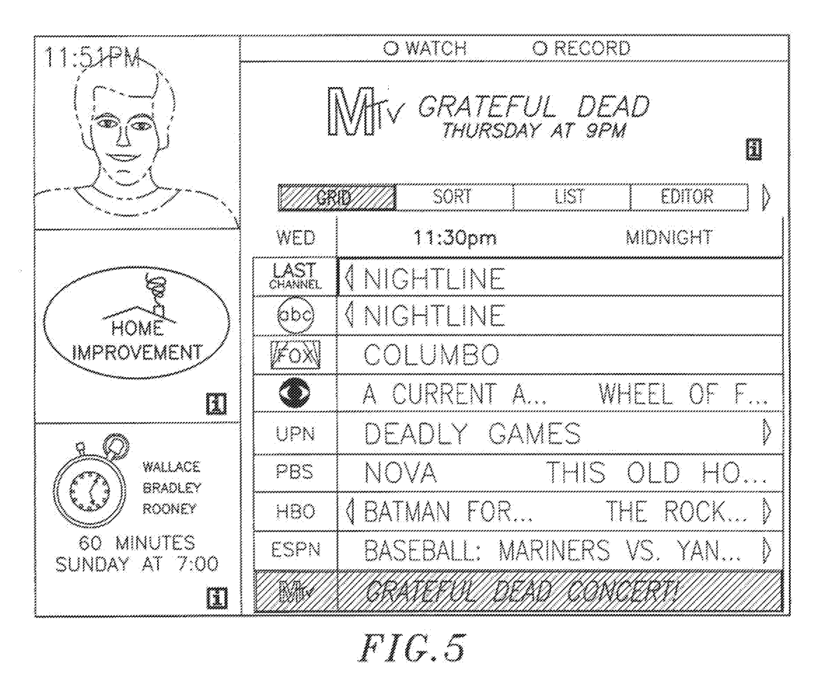

FIG. 5 shows an exemplary screen for highlighting a channel Ad, according to an embodiment of the invention;

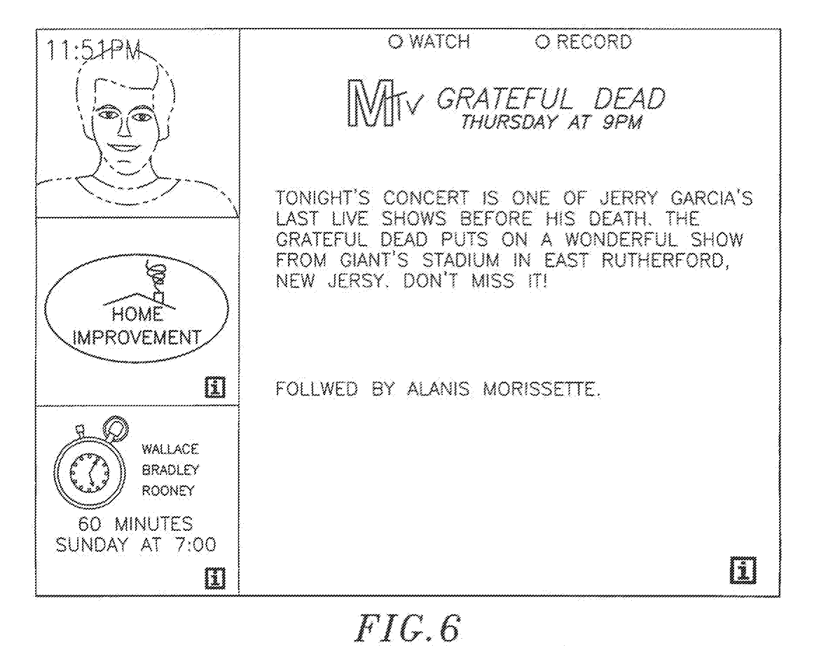

FIG. 6 shows an exemplary screen for expanding a channel Ad, according to an embodiment of the invention;

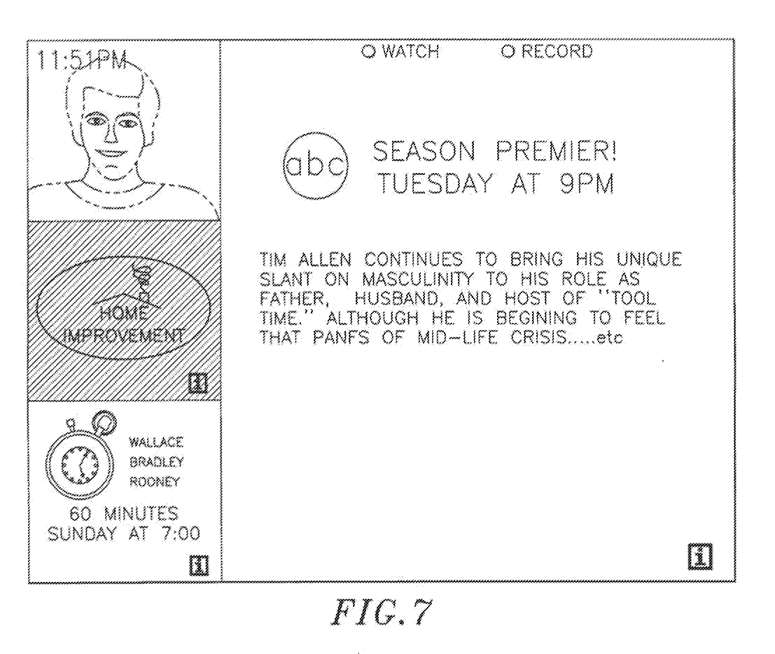

FIG. 7 shows an exemplary screen for highlighting a panel Ad, according to an embodiment of the invention; and

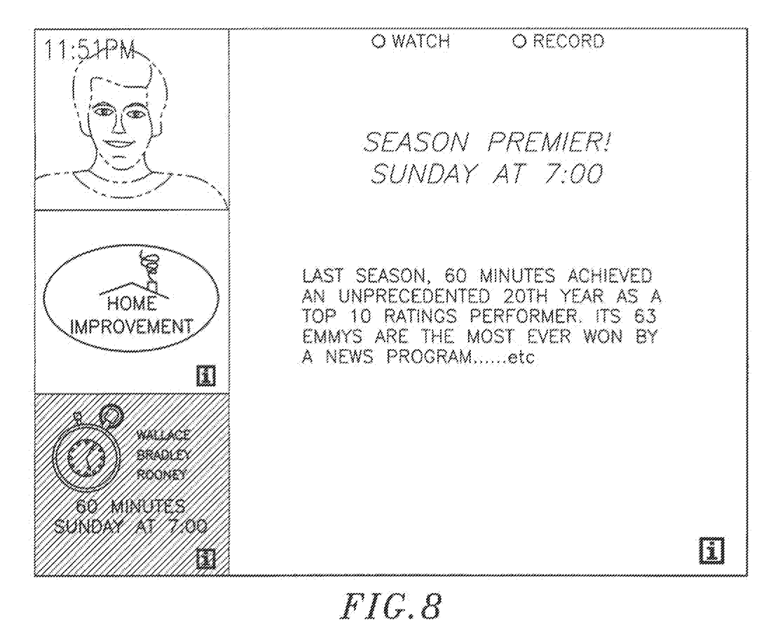

FIG. 8 shows an exemplary screen for highlighting another panel Ad, according to an embodiment of the invention.

### DETAILED DESCRIPTION

The present invention controls the traffic of advertisements to be displayed on the viewer's display device and determines an appropriate amount of money for which each advertiser should be billed for the display of that advertiser's Ad Creative.

Each advertiser will pay the EPG provider to display the Ad Creative(s) provided by that advertiser. Multiple advertisers will want the EPG provider to display the Ad Creative(s) provided by that advertiser according to agreed upon display terms. Display terms will include one or more of a number of elements, including but not limited to:
1.) Type of Advertisement;
2.) Placement/Location on the Display Device;
3.) Proportional “Size” of the Advertisement;
4.) Time Duration for Each Display of a Particular Advertisement;
5.) Expansion Specifications;
6.) Access Relationship to Advertising Target Specifications;
7.) Display Relationship to Viewer Profile Information and Characteristics;
8.) Scheduling Specifications;
9.) Ad Creative Elements;
10.) Ad Interactivity

In one embodiment of the present invention, the traffic and billing control terms are defined for administration at the EPG distribution head-end only (a “Head-End Traffic and Billing Control System,” also referred to as a “Head-End Embodiment”). Attached hereto as Appendix A, and incorporated in full here by reference as if fully stated here, are the specifications for one Head-End Embodiment of the present invention.

In another embodiment of the present invention, the traffic and billing control terms are defined for administration in part at the individual viewer's television, and in part, at the EPG distribution head-end (a “Distributed Traffic and Billing Control System,” also referred to as a “Distributed Embodiment”). Typically, a Distributed Traffic and Billing Control System would have a back-link from the viewer's television to the head-end. The back-link could be direct, via a network back-link such as through the Internet, a communication requiring manual intervention, or some other method to communicate certain information collected about the advertisement terms for a particular advertisement to the EPG distribution head-end.

Because of the nature of some of the above-identified terms, in some embodiments of the present invention, billing for presentation of any particular advertisement can be variable according to the viewer-by-viewer display results.

### 1.) Type of Advertisement

The type of advertisement considers, among other things, what is being advertised. That is, whether a product is being advertised, or whether a future television program being advertised, etc. The type of advertisement also considers the format of the particular advertisement. A particular EPG system can display advertisements in a number of ways, in different areas of the EPG display, and at different locations within the EPG operation. For instance, an EPG, such as Gemstar's Guide 98, provides an EPG Grid Guide display that presents the Grid Guide program selection in one fixed portion of the display monitor's screen. The exemplary EPG displays the real-time video of the current television program in a PIP (Picture-in-Picture) Window (also referred to as a PIG (Picture-in-Guide) Window, as shown in FIG. 3. In other fixed display window locations, the EPG displays what are referred to as panel ads. Within the television program listing of the Grid Guide, the EPG can display what are referred to as channel ads. FIG. 3 illustrates examples of each of the above-described screen elements.

The present invention provides the EPG administrator to charge a different amount for different types of the advertisements. For instance, the present invention provides the EPG administrator with the option of charging more money for a particular time slot for a Panel Ad than for a Channel Ad.

The present invention further provides for traffic control for the presentation of each type of advertisement. For instance, the present invention provides the EPG administrator to choose to restrict the number of product advertisements that are displayed at any one time on the viewer's EPG display. Furthermore, the present invention provides the EPG administrator with the option of choosing to restrict the number of channel ads that are displayed at any one time on the viewer's EPG display.

### 2.) Placement/Location on the Display Device

The present invention provides the EPG administrator with the option of charging different amounts for advertisements depending upon the placement and location of the advertisement in the EPG display. For instance, the EPG administrator can charge more money for a particular time slot for the Panel Ad that is located as seen in FIG. 3 directly below the PIP Window (Panel Ad #1) than for the Panel Ad located at the bottom left corner of the screen (Panel Ad #2).

There are multiple types of Channel Ads, some of which do not occupy a fixed position. For the Channel Ads that do occupy a fixed position, the present invention provides the option of charging, e.g., more money for a Channel Ad that is displayed toward the top of the Grid Guide program listing than for one that is displayed at the bottom of the listing.

There are different variable location Channel Ad types. There is a “Relative” Channel Ad that appears in a position relative to the top of the Grid. Relative Channel Ads are spaced every n channel slots. Relative Channel Ads appear and disappear as the viewer moves through the pages of the Grid Guide. A location for the first ad is selected on the first page of the Grid Guide; subsequent copies of the ad follow every n channel slots in the Grid Guide.

Another type of variable location ad type is the “Parent” Channel Ad. Parent Channel Ads are linked to a specific channel listing located directly above the ad in the Grid Guide.

One embodiment of different type of advertisements in an EPG is described in the Advertising Specifications attached hereto as Appendix B and which is incorporated in full here by reference as if fully stated here.

Another type of EPG initiated advertisement is displayed when the viewer is watching television in full screen mode. One way that the EPG presents advertisements during full screen television mode is that it displays the advertisement in the PIP Window of the television as the real-time video programming of the currently tuned program continues to be displayed on the main portion of the television display monitor.

Another way that the EPG presents advertisements during full screen television mode is in the form of an overlay. The overlay advertisement can be opaque or can appear as a translucent “watermark.” The overlay advertisement can be static or dynamic. As an example, consider the viewer that is watching the Super Bowl. When the team most favored in the viewer's geographic area makes a touchdown, a figure such as the Energizer Bunny moves from one side of the screen to the other at the bottom of the screen.

The present invention allows the EPG Administrator to charge distinct amounts depending upon the placement and location for each of the different ad placement types.

### 3.) Proportional “Size” of the Advertisement

The present invention allows the EPG administrator to charge an amount dependent upon the proportional size of the advertisement to be displayed as compared to the entire display area available on the viewer's display device. The size of the advertisement can be defined by the number of “pixels” required to display the advertisement. In one embodiment of the present invention, different advertisement types are of fixed size. In such an embodiment, the proportional size billing factor is not typically used. However, in other embodiments, advertisement types can differ in size. For instance, consider Panel Ad #1 shown in FIG. 3. Panel Ad #1 could be shared by two or more advertisers. The present invention provides the EPG administrator to bill according to the relative size of each ad displayed within the Panel Ad #1 Window.

### 4.) Time Duration for Each Display of a Particular Advertisement

In one embodiment of the present invention, each advertiser pays a pre-determined amount of money for the opportunity to display a particular advertisement during a pre-defined time slot. One embodiment of time slots and time avails are described in Appendix A hereto which has previously been incorporated by reference in this application.

The advertisement is predefined for display as a particular ad type for display in a particular location on the EPG display screen. With the present invention, during the above-mentioned pre-defined time slot, more than one advertisement can be rotated for display for a pre-determined amount of time.

In one embodiment of the present invention, the advertiser is billed for a time duration for the display of the advertisement calculated based on the pre-defined time slot and the pre-defined rotation schedule during that time slot. In such an embodiment, the billing does not reflect whether a viewer actually views the advertisement. One embodiment of rotation of advertisements is described in Advertising Specifications attached hereto as Appendix B and which has previously been incorporated in full in this application by reference.

In another embodiment of the present invention, the billing for a particular advertisement depends upon the actual duration of time for which the advertisement is displayed to, and viewed by, the television viewer. Typically, such an embodiment would require a back-link from the individual viewer's television to the EPG distribution head-end.

### 5.) Expansion Specifications

Advertisements can be expanded to provide the viewer with additional information about the advertised product or program. The viewer uses the EPG to request the additional information. For instance, the viewer can select an information icon on the advertisement display using the viewer's remote control device. The additional information can be displayed on some portion of the display screen such as, for example, in the information box as shown in FIG. 3. More than one level of additional information can be available for display by the EPG. Alternatively, the additional information can include functions for recording or tuning to a particular program, as described in section 1.3.2.3 of Appendix A. The present invention allows the EPG administrator to charge the advertiser for the additional information that must be stored to accompany the advertisement. In a Distributed embodiment of the invention, the EPG administrator can also charge the advertiser for actual viewer accesses to the additional information.

### 6.) Access Relationship Advertising Target Specifications

The present invention provides the EPG administrator with the capability to narrowly target particular advertisements based on a viewer's actions with the EPG. That is, the present invention provides the EPG administrator with the capability to specify that a particular advertisement be displayed on a viewer's television screen under certain conditions, those conditions being determined by the viewer's operation of, and access to, the EPG.

For instance, if the viewer highlights a particular program listing, the EPG administrator can instruct the EPG to display a particular advertisement. In another instance, the EPG administrator can instruct the EPG to display a particular advertisement depending upon what screen or mode of the EPG that the viewer activates. For example, if the viewer accesses the movie theme screen of the EPG, the EPG administrator can instruct the EPG to display a particular advertisement. As another example, the EPG administrator can instruct the EPG to display a particular advertisement as the first Panel Ad #1 every time that the viewer first turns on the television according to a particular schedule (a day, a week, etc.). The types of access relationships that can be communicated to the EPG as a condition for display of an advertisement are described in co-pending U.S. application Ser. No. 09/120,488, which is incorporated in full by reference here as if fully stated here.

Access relationship targeting can be accomplished in both Head-End and Distribution Embodiments. For instance, the EPG administrator can instruct the EPG to display a particular advertisement depending on data coded in the information packets sent to the viewer's television. The EPG system at the viewer's television decodes the instructions and displays the advertisement when the specified conditions are met.

Billing for access relationship targeting in a Head-End Embodiment would provide the advertiser with the opportunity to have its advertisement displayed according to the described criteria but would not be dependent upon the number of times that the advertisement was actually displayed. On the other hand, billing for access relationship targeting in a Distributed Embodiment would provide the EPG administrator the opportunity to charge the advertiser for each display of the advertisement—the information concerning the number of displays would be collected through a back-link.

### 7.) Display Relationship to Viewer Profile Information and Characteristics

The present invention provides the EPG administrator with the capability to narrowly target particular advertisements based on a viewer's historical television viewing and video recording viewing patterns and/or characteristics that can be determined by collection of historical viewer information. The types of viewer profile characteristics and relationships that can be communicated to the EPG as a condition for display of an advertisement are described in co-pending U.S. application Ser. No. 09/120,488, which is incorporated in full by reference here as if fully stated here.

The present invention provides the EPG administrator with the capability to specify that a particular advertisement be displayed on a viewer's television screen under certain conditions, those conditions being determined by the viewer's historical viewing patterns and other viewer profile characteristics. For instance, if the viewer typically watches sports programs, the EPG administrator can instruct the EPG to display a particular advertisement related to sports. As another example, if the viewer typically watches the programs related to animals, the EPG administrator can instruct the EPG to display a particular advertisement concerning dog food.

The EPG administrator would publish the conditional criteria for this type of advertising to the advertisers. The advertisers would define for the EPG administrator the conditions for which a particular advertisement should be displayed.

Viewer profile targeting can be accomplished in both Head-End and Distribution Embodiments. For instance, the EPG administrator can instruct the EPG to display a particular advertisement depending on data coded in the information packets sent to the viewer's television. In a Head-End embodiment, the EPG system local to the viewer's television would collect the viewer profile and characteristic data and store the information in the memory of the local system. In a Head-End Embodiment, the local EPG system at the viewer's television decodes the instructions and displays the advertisement when the specified conditions are met.

Billing for viewer profile targeting in a Head-End Embodiment would provide the advertiser with the opportunity to have its advertisement displayed according to the described criteria but would not be dependent upon the number of times that the advertisement was actually displayed. On the other hand, billing for viewer profile targeting in a Distributed Embodiment would provide the EPG administrator the capability to charge the advertiser for each display of the advertisement—the information concerning the number of displays would be collected through a back-link.

### 8.) Scheduling Specifications

The present invention provides the EPG administrator with the capability to schedule a particular advertisements for display on a particular date, or day of the week for a particular time frame. The present invention also provides the capability to schedule a particular advertisement for display during a particular time slot. The EPG administrator can further schedule a particular set of advertisements for a rotation of advertisements during a particular time slot. The rotation and scheduling of advertisements is discussed in both Appendix A and Appendix B to this application, both of which have been previously incorporated by reference in full in this application.

The present invention further provides the EPG administrator with the capability to bill according to the particular date, day of the week, time slot, and rotation schedule defined for a particular advertisement.

### 9.) Ad Creative Elements

Some Ad Creatives will be comprised of text and static graphical objects for display with a pre-determined color palette. The present invention provides the EPG administrator to bill according to, among other things, the number of colors defined in a supporting color palette, the amount of storage required to store the text and graphical objects of an Ad Creative. Other Ad Creatives may include additional and/or alternative advertising elements, including but not limited to: dynamic graphical objects, sound, video, and other types of advertising elements.

The present invention allows the EPG administrator to bill according to the storage requirements of the advertising elements. The present invention further allows the EPG administrator to define the magnitude of the visual impact of a particular advertisement, and to bill accordingly.

Consider, for instance, a static, text and graphic object Channel Ad for a particular horse racing event. For comparison to the static channel ad, visualize a channel ad that displays a panoramic video of horses racing from the left side of the channel ad to right side of the channel ad. The present invention provides the EPG administrator with the capability to set a higher billing amount for the higher visual impact of the panoramic video Channel Ad than for the static Channel Ad. Graphic and text dynamics are described in the Advertising Specifications attached hereto as Appendix B and which has been previously incorporated in full in this application by reference.

Ad Creatives will be accessible to the host EPG display system by, among other ways: 1.) through direct access by the host EPG display system at the viewer's television to one or more libraries of advertisements residing on a network system, such as the Internet; 2.) by transmitting advertisements to be displayed by the host EPG display system to one or more libraries at a central location at the head end of a television EPG distribution system for subsequent distribution of such advertisements to each television EPG, though, e.g., the Vertical Blanking Interval (the “VBI”) and by the host EPG display system at the viewer's television storing the advertisements received from the VBI in a database of advertisements; 3.) through direct access by the head end of a television EPG distribution system to one or more libraries of advertisements residing on a network system, such as the Internet for selection by the head end of appropriate advertisements for subsequent distribution of such advertisements to each television EPG, though, e.g., the Vertical Blanking Interval (the “VBI”) and by the host EPG display system at the viewer's television storing the advertisements received from the VBI in a database of advertisements.

### 10.) Ad Interactivity

Advertisements displayed in the EPG can provide interactivity with the television and the video recorder. For instance, “Tune-in” Ads allow the viewer to tune directly to a show in progress from a highlighted ad block if the ad block has program information associated with it. Typically, the viewer selects the program for tuning by using the viewer's remote control device. For instance, the viewer can press the remote control enter button while a Tune-in Ad Block is highlighted.

“Direct-record” Ads allow the viewer to record a show in progress or schedule a program for recording at a later time. A program can be designated for recording from a highlighted Direct-record Ad block if the ad block has program information associated with it. Typically, the viewer uses the viewer's remote control device to instruct the EPG to schedule a program for recording. In one embodiment, the viewer highlights the Direct-record ad block and “presses” the right action button on the Grid Guide.

“Watch” Ads with associated program information allow a viewer to place a future-scheduled program on the viewer's Watch list.

The present invention provides the EPG Administrator with the capability to charge different amounts for the different types of interactivity available for each advertisement. Appendix B hereto, which has previously been incorporated in full into this application, contains a description of some of the different types of ad interactivity.

1-22. (canceled)

23. A method for displaying advertisements in an interactive television program guide (EPG) comprising:
receiving a first user indication at a first time to access a page of the EPG, wherein the page of the EPG includes an advertisement region;
identifying a first rotation queue assigned to the advertisement region based on the first time;
accessing the first rotation queue to determine which of a first plurality of advertisements is to be displayed next in the advertisement region, wherein the first rotation queue defines a first sequence in which each of the first plurality of advertisements is to be displayed;
receiving a second user indication at a second time to access the page of the EPG;
identifying a second rotation queue assigned to the advertisement region based on the second time; and
accessing the second rotation queue to determine which of a second plurality of advertisements is to be displayed next in the advertisement region, wherein the second rotation queue defines a second sequence in which each of the second plurality of advertisements is to be displayed.

24. The method of claim 23, wherein identifying the first rotation queue comprises determining that the first rotation queue has an associated time slot inclusive of the first time, and wherein identifying the second rotation queue comprises determining that the second rotation queue has a different associated time slot inclusive of the second time.

25. The method of claim 23 further comprising:
displaying, in response to accessing the first rotation queue, the advertisement determined from the first rotation queue in the advertisement region;
updating the first rotation queue to indicate that a different one of the first plurality of advertisements is to be displayed next in the advertisement region;
displaying, in response to accessing the second rotation queue, the advertisement determined from the second rotation queue in the advertisement region; and
updating the second rotation queue to indicate that a different one of the second plurality of advertisements is to be displayed next in the advertisement region.

26. The method of claim 23, wherein the advertisement region is a panel advertisement region located in an area of the EPG outside a grid area.

27. The method of claim 23, wherein each of the first plurality of advertisements has an associated weight, and wherein the first sequence is a weighted sequence in which one of the first plurality of advertisements associated with a first weight is displayed less often than another one of the first plurality of advertisements associated with a second weight greater than the first weight.

28. The method of claim 23, wherein each of the first sequence and the second sequence is one of a random sequence and a fixed sequence.

29. The method of claim 23, wherein one of the first plurality of advertisements is a placeholder advertisement.

30. The method of claim 23, wherein multiple categories are displayed on the page of the EPG, the method further comprising:
receiving a user selection of one of the categories; and
changing the advertisement displayed in the advertisement space in response to the user selection.

31. The method of claim 23, wherein the displayed advertisement is surrounded by a border the color of which is indicative of an action associated with the advertisement.

32. The method of claim 31, wherein a program is presented within the advertisement, and wherein the action is one of a setting to record the program and a setting to watch the program.

33. The method of claim 23 further comprising automatically changing the advertisement displayed in the advertisement space at predefined intervals of time.

34. A system for displaying advertisements in an interactive television program guide (EPG) comprising:
processing circuitry configured to:
receive a first user indication at a first time to access a page of the EPG, wherein the page of the EPG includes an advertisement region;
identify a first rotation queue assigned to the advertisement region based on the first time;
access the first rotation queue to determine which of a first plurality of advertisements is to be displayed next in the advertisement region, wherein the first rotation queue defines a first sequence in which each of the first plurality of advertisements is to be displayed;
receive a second user indication at a second time to access the page of the EPG;
identify a second rotation queue assigned to the advertisement region based on the second time; and
access the second rotation queue to determine which of a second plurality of advertisements is to be displayed next in the advertisement region, wherein the second rotation queue defines a second sequence in which each of the second plurality of advertisements is to be displayed.

35. The system of claim 34, wherein identifying the first rotation queue comprises determining that the first rotation queue has an associated time slot inclusive of the first time, and wherein identifying the second rotation queue comprises determining that the second rotation queue has a different associated time slot inclusive of the second time.

36. The system of claim 34, wherein the processing circuitry is further configured to:
display, in response to accessing the first rotation queue, the advertisement determined from the first rotation queue in the advertisement region;
update the first rotation queue to indicate that a different one of the first plurality of advertisements is to be displayed next in the advertisement region;
display, in response to accessing the second rotation queue, the advertisement determined from the second rotation queue in the advertisement region; and
update the second rotation queue to indicate that a different one of the second plurality of advertisements is to be displayed next in the advertisement region.

37. The system of claim 34, wherein the advertisement region is a panel advertisement region located in an area of the EPG outside a grid area.

38. The system of claim 34, wherein each of the first plurality of advertisements has an associated weight, and wherein the first sequence is a weighted sequence in which one of the first plurality of advertisements associated with a first weight is displayed less often than another one of the first plurality of advertisements associated with a second weight greater than the first weight.

39. The system of claim 34, wherein each of the first sequence and the second sequence is one of a random sequence and a fixed sequence.

40. The system of claim 34, wherein one of the first plurality of advertisements is a placeholder advertisement.

41. The system of claim 34, wherein the processing circuitry is further configured to:
display multiple categories on the page of the EPG;
receive a user selection of one of the categories; and
change the advertisement displayed in the advertisement space in response to the user selection.

42. The system of claim 34, wherein the displayed advertisement is surrounded by a border the color of which is indicative of an action associated with the advertisement.

43. The system of claim 42, wherein a program is presented within the advertisement, and wherein the action is one of a setting to record the program and a setting to watch the program.

44. The system of claim 34, wherein the processing circuitry is further configured to automatically change the advertisement displayed in the advertisement space at predefined intervals of time.
